(19) United States
(12) Patent Application Publication
(10) Pub. No.: US 2009/0287833 A1
(43) Pub. Date: Nov. 19, 2009

(54) Security-Based Presentation in Client Application Software

(76) Inventor: Steven Mark Paris, Watertown, MA (US)

Correspondence Address: Kenneth F. Kozik, 43 Mohawk Drive, Acton, MA, 01720-2343, US

(21) Appl. No.: 12/122,188

(22) Filed: May 16, 2008

(51) Int. Cl. G06F 15/16

(52) U.S. Cl. 709/229

(57) ABSTRACT

Methods and apparatus, including computer program products, for security-based presentation in client application software. A network includes one or more client systems coupled to one or more servers, a server including an application adapted to compare a request received from a client application for particular data, metadata and descriptors, together with authorization information, against the access control codes, keys or lists stored in a server-based set of tables or lists and use the results of the comparison to reply to the request affirmatively with the data, metadata and descriptors or negatively with either an error code, error message or null result.

### BACKGROUND

At least some embodiments disclosed herein relate to data storage, and more particularly, to security-based presentation in client application software.

### SUMMARY OF THE DESCRIPTION

The present invention provides methods and apparatus, including computer program products, for security-based presentation in client application software.

In one aspect, the invention features a method including, in a client server network, executing a client application in a client system, establishing a communications connection between the client system and a server in the client server network, submitting a request from the client application to the server to obtain information, if a data item's authorization level is greater than or forbidden for this client, returning an error message and closing the communication connection to the server, if there are no more items to be served, transmitting an indication to the client application that it is finished and closing the communication connection to the server, if the data item's authorization level is less than or equal to the level of this client, looking up the corresponding formatting information and presentation device information and communicating data, format and descriptor over the network to the client software application, receiving the data, format and descriptor and constructing a control adequate to present the data, and repeating submitting, returning, transmitting, looking up and receiving.

In another aspect, the invention features a network including one or more client systems coupled to one or more servers, a server including an application adapted to compare a request received from a client application for particular data, metadata and descriptors, together with authorization information, against the access control codes, keys or lists stored in a server-based set of tables or lists and use the results of the comparison to reply to the request affirmatively with the data, metadata and descriptors or negatively with either an error code, error message or null result.

The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

The embodiments are illustrated by way of example and not limitation in the figures of the accompanying drawings in which like references indicate similar elements.

FIG. 1 is a block diagram of an exemplary system.

FIG. 2 is a flow diagram of a process.

FIG. 3 is an example of Java® language code.

FIG. 4 is an example of database tables and fields.

### DETAILED DESCRIPTION

The following terms are helpful when reading this detailed description.

A “server” is typically a passive computing system that waits for requests over communication networks from one or more “clients” to perform some function. When the server has performed the function, it “serves” the answer, or result, over the network.

A “client” is typically an active computing system. A client initiates requests to one or more servers over a communications network and waits for the responses. The client is the computing system that communicates with an end user.

A “container” is a class, a data structure, or an abstract data type whose instances are collections of other objects. Containers are used to store objects in an organized way following specific access rules.

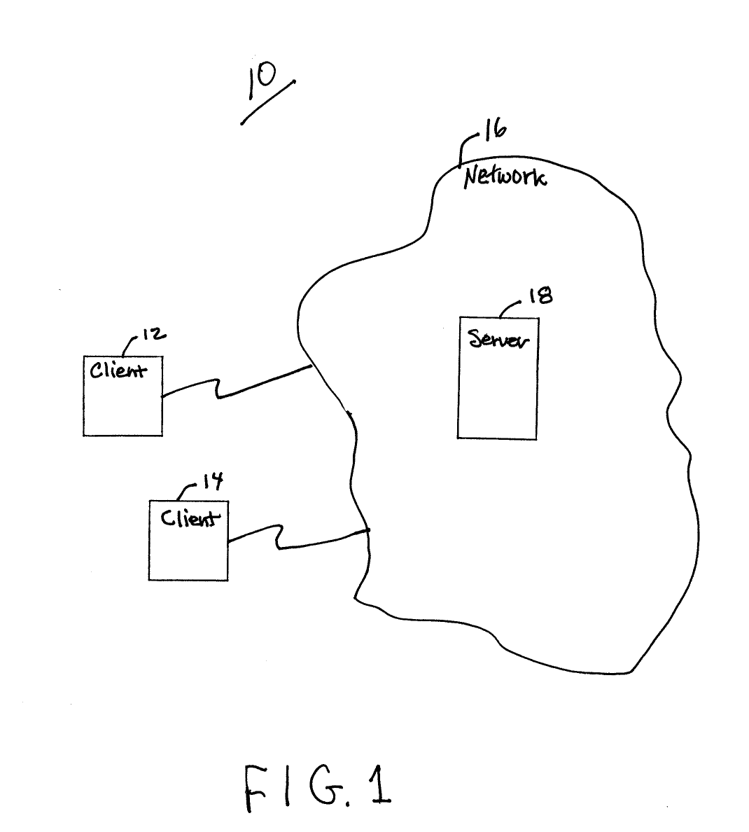

As shown in FIG. 1, an exemplary system 10 includes one or more client systems 12, 14 coupled to a network 16. The network 16 includes a group of interconnected computer systems. These computer systems in the network 16 include at least one server 18. The client systems 12, 14 can communicate with and send and receive information between one another over the network 16. Client systems 12, 14 can be large computer systems but are more often smaller desktop, laptop or personal computing devices with small amounts of memory and storage.

The server 18 can include one or more computers or processors, together with large amounts of random access memory (RAM) and secondary storage, such as disk drives, optical disk drives, and so forth.

The server 18 holds data. This data can be arranged in lists, tables, arrays or other data structures. Collections of data can be arranged inside larger conglomerations called databases or repositories.

Client software applications executing on the client systems 12, 14 typically need to access the data that is contained on one or more server systems such as server 18. Example client software applications executing on the client systems 12, 14 include library terminal application software that accesses data residing in the server 18, e.g., databases of online articles and documents. A Web browser is a typical client application that can access large amounts of data on remote server systems such as server 18.

Web browser applications communicate and understand Hypertext Markup Language (HTML), which contains both data and, in many cases, the formatting for that data. In general, HTML is the set of markup symbols or codes inserted in a file intended for display on a Web browser page. The markup tells the Web browser how to display a Web page's words and images for a user. Each individual markup code is referred to as an element (sometimes referred as a tag). Some elements come in pairs that indicate when some display effect is to begin and when it is to end.

There is no similar protocol for stand-alone client applications. In addition, it may very well be the case that if a client application does not possess an authorization to view one or more pieces of data residing on the server 18, not even the device used to display or present the data should be displayed or presented. For example, in a client application, a grouping of data might be displayed in a table, an X-ray might be displayed as a Joint Photographic Experts Group (JPEG) image and a Beethoven symphony might customarily have a set of “controls” used to start, stop, pause, “fast forward” and “reverse” the sound recording. If the client application does not have the proper authority to view the table or X-ray image or listen to the symphony, then those data should not be displayed or presented and, in fact, neither should the tables, JPEG frame or sound controls. The client application should not only not know what the data is, but not even the type of the data.

Using the present method, client application writers can be assured that users lacking authority will not gain access to data or, in many cases, know the type of that data.

The present method enables application creators to vary, ad hoc, the “look and feel” of their client applications by changing the data, metadata (i.e., structured data that describes the characteristics of a resource) and descriptors (e.g., index terms) stored on the server.

The present method enables smaller client applications. In most instances, the client application need only instantiate or activate, at execution time, controls, devices or mechanisms that the server indicates. The client application need not implement its own forms, controls and other devices, but merely “factory methods” that understand how to create these devices at execution time.

Since display or presentation devices are created ad hoc as needed, client applications may be faster as devices that are not needed are not created.

The client application does not necessarily need to know the structure of the storage mechanisms on the server 18. That is, instead of embedding programming features that cause a lookup into well-defined sets of tables or lists, the client application merely needs to send lists of keys, codes, identification numbers, hashes or other identifying characteristic of the data in order to receive not only the data, but also the formatting and presentation devices to be used to display that data.

Client applications may be tailored for different users, environments and localities. Data viewed on a client desktop computer may appear entirely different in a foreign country, on a smart mobile telephone or for two different users.

The present method enables client application software to communicate over a network to a server and request not only data to be presented to an end user, but also the characteristics of the data and the type of container in which the data should be presented, if, and only if the client application has the requisite permission to obtain the data, its characteristics and its container.

The present invention defines the protocol to be used among the client and server software in order to ensure that only data and containers requested are served by the server.

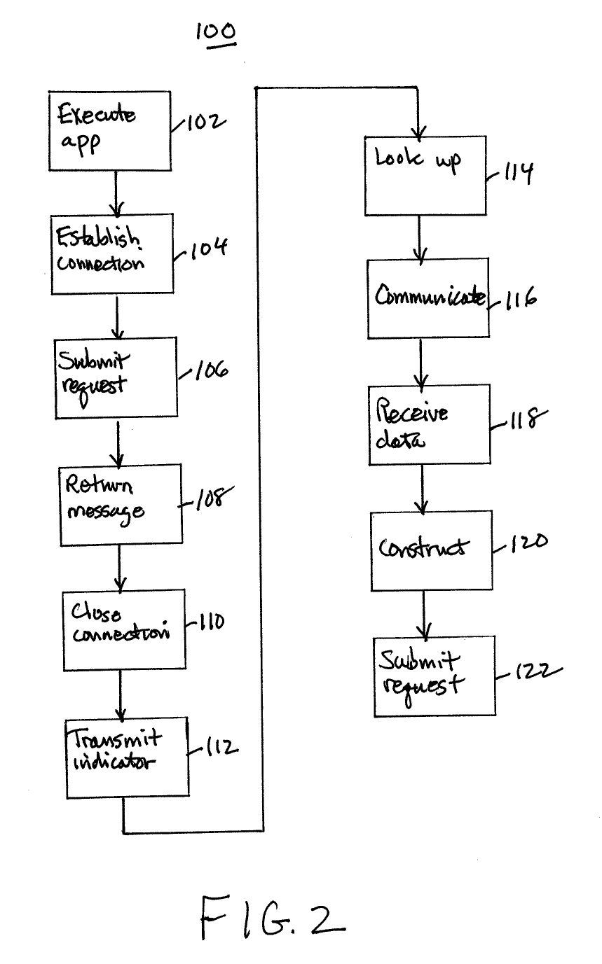

As shown in FIG. 2 a process 100 includes an end user executing (102) a client application. The client application will, typically, request a username, password and/or other unique identifiers from the end user in order to permit access to server information. In higher-security settings, the client system may incorporate biometric input (e.g., fingerprint or iris scanning technology), long and complex user identifications (IDs) and/or hardware authentication devices.

Once the end user has successfully initiated the client application, process 100 establishes (104) a communications connection with a server.

Process 100 submits (106) a request from the client application to the server to obtain information. The server software will find the first data item to be communicated.

If the data item's authorization level is greater than, or is in some manner forbidden for this client, the server software returns (108) an error message, code, number or NULL result and indicates it is finished to the client application and closes (110) the communication connection to the server.

If there are no more items to be served, process 100 transmits (112) an indication to the client application that it is finished and closes (110) the communication connection to the server.

If the data item's authorization level is less than or equal to the level of this client, the server software looks up (114) the corresponding formatting information and presentation device information. Three items are communicated (116) over the network to the client software application, i.e., data, format and presentation device descriptor(s).

The client application receives (118) the data, format and descriptor(s) and constructs (120) a control adequate to present this data. For textual or numeric data, there can be literally dozens of combinations of text font, size, style, color and alignment. For sound, picture and video data, the descriptor specifies the type of software and/or hardware device to present the sound, picture or video. Other devices may be able to reproduce smells, tastes or tactile feelings. Three-dimensional viewing systems are becoming more widespread and available for use.

The client application submits (122) a request and repeats the steps of look up (114), communicating (116), receiving (118), constructing (120).

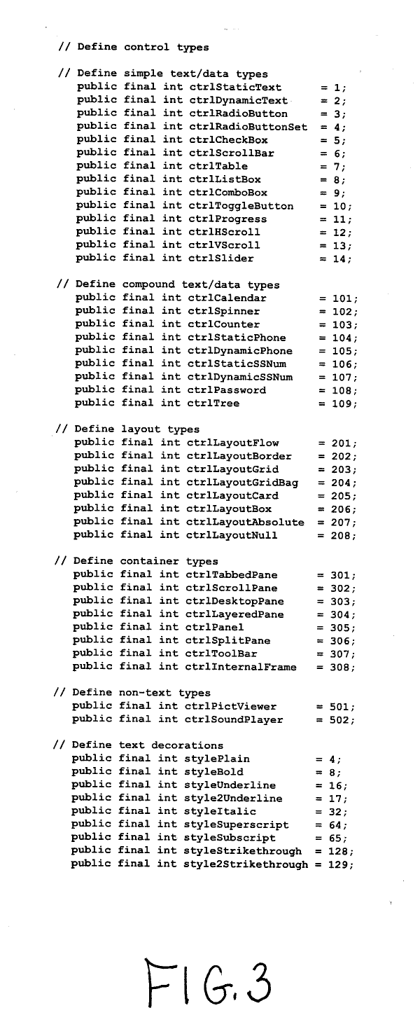

FIG. 3 is one illustrative example of Java language code that enumerates permissible control types.

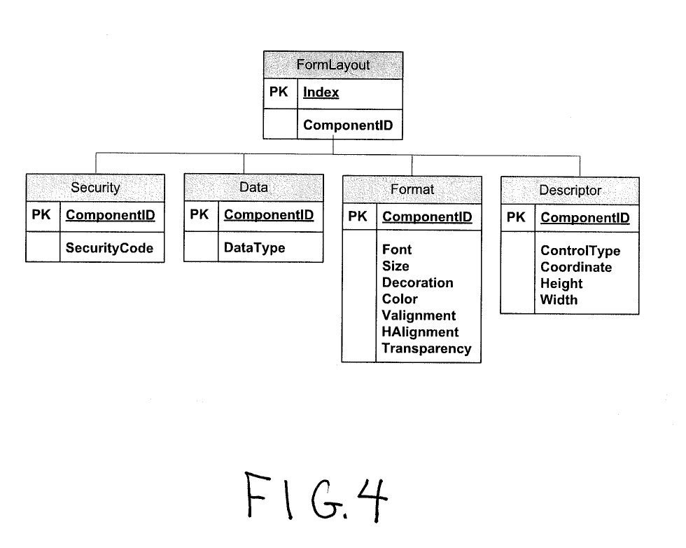

FIG. 4 is one illustrative example of several database tables illustrating the relationship between sample security, data, formatting and control descriptor.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A method comprising:
in a client server network, executing a client application in a client system; establishing a communications connection between the client system and a server in the client server network;
submitting a request from the client application to the server to obtain information;
if a data item's authorization level is greater than or forbidden for this client, returning an error message and closing the communication connection to the server;
if there are no more items to be served, transmitting an indication to the client application that it is finished and closing the communication connection to the server;
if the data item's authorization level is less than or equal to the level of this client, looking up the corresponding formatting information and presentation device information and communicating data, format and presentation device descriptor over the network to the client software application;
receiving the data, format and descriptor and constructing a control adequate to present the data; and
repeating submitting, returning, transmitting, looking up and receiving.

2. The method of claim 1 wherein executing the client application comprises inputting a username, password or biometric information.

3. The method of claim 2 wherein the biometric information includes iris scan information.

4. A computer program product, tangibly embodied in an information carrier, for proper presentation of data in a client application, the computer program product being operable to cause data processing apparatus to:
in a client server network, execute a client application in a client system;
establish a communications connection between the client system and a server in the client server network;
submit a request from the client application to the server to obtain information;
if a data item's authorization level is greater than or forbidden for this client, return an error message and close the communication connection to the server;
if there are no more items to be served, transmit an indication to the client application that it is finished and close the communication connection to the server;
if the data item's authorization level is less than or equal to the level of this client, look up the corresponding formatting information and presentation device information and communicate data, format and presentation device descriptor over the network to the client software application;
receive the data, format and descriptor and construct a control adequate to present the data; and
repeat submitting, returning, transmitting, looking up and receiving.

5. The computer program product of claim 1 wherein executing the client application comprises inputting a username, password or biometric information.

6. The computer program product of claim 2 wherein the biometric information includes iris scan information.

7. A network comprising:
one or more client systems coupled to one or more servers, a server comprising an application adapted to compare a request received from a client application for particular data, metadata and descriptors, together with authorization information, against the access control codes, keys or lists stored in a server-based set of tables or lists and use the results of the comparison to reply to the request affirmatively with the data, metadata and descriptors or negatively with either an error code, error message or null result.

8. The network of claim 7 wherein the server includes a set of tables or lists, either existing alone or inside a database or repository, containing data intended to be displayed, played or sensed inside a client-based application, the senses including sight, sound, touch, taste and smell.

9. The network of claim 7 wherein the server includes a set of tables or lists, either existing alone or inside a database or repository, containing metadata corresponding to the data and used in order to format the data into a form other than the original binary-based representation in the tables or lists.

10. The network of claim 7 wherein the server includes a set of tables or lists, either existing alone or inside a database or repository, containing descriptors corresponding to the data and that specify the kind of control, display or sensing device within which the data is to be presented.

11. The network of claim 7 wherein the server includes a set of tables or lists, either existing alone or inside a database or repository, containing access control codes, keys or lists corresponding to the data and that are used to permit or deny access to the data, metadata and display descriptors.

12. The method of claim 1 wherein the client application issues requests for particular data, metadata and descriptors, together with authorization information to one or more server-based systems holding the data, metadata and descriptors.

13. The method of claim 9 wherein the client application formats the data using the instructions specified by and included in the metadata to produce an output and then displays, plays or otherwise presents this output in the control, display or sensing device described by a descriptor.
